(19) United States
(12) Patent Application Publication
(10) Pub. No.: US 2024/0095192 A1
(43) Pub. Date: Mar. 21, 2024

(54) MEMORY SYSTEM, CONTROL DEVICE, AND METHOD

(71) Applicant: Kioxia Corporation, Tokyo (JP)

(72) Inventor: Goichi OOTOMO, Kawasaki Kanagawa (JP)

(73) Assignee: Kioxia Corporation, Tokyo (JP)

(21) Appl. No.: 18/461,661

(22) Filed: Sep. 6, 2023

(30) Foreign Application Priority Data
Sep. 21, 2022 (JP) 2022-150540

(51) Int. Cl. G06F 13/16; G06F 11/10

(52) U.S. Cl. CPC G06F 13/1621; G06F 11/1068; G06F 13/1668

(57) ABSTRACT

According to one embodiment, a memory system includes a semiconductor memory device and a control device. The memory system includes a first device and first channels. The first channels are each connected to one or more second devices. The control device is connected to the first device via a second channel. The control device includes first circuits and a second circuit. The first circuits each execute data transfer to the second device as an access destination. The second circuit is provided between the first circuits and the second channel. The second circuit combines data from the first circuits and transfers the combined data to the second channel at a transfer rate higher than that of pre-combining data. The second circuit divides data received via the second channel and distributes pieces of divided data to the first circuits at a transfer rate lower than that of pre-dividing data.

### CROSS-REFERENCE TO RELATED APPLICATIONS

This application is based upon and claims the benefit of priority from Japanese Patent Application No. 2023-150540, filed on Sep. 21, 2022, the entire contents of which are incorporated herein by reference.

### FIELD

Embodiments described herein relate generally to a memory system, a control device, and a method.

### BACKGROUND

There is a memory system in which a bridge chip is provided between a memory controller and a plurality of memory chips. The memory controller is a control device that controls each of the memory chips via the bridge chip. Each of the memory chips is connected to the bridge chip via any of channels. In such a memory system, the memory controller accesses the plurality of memory chips such that data transfer is executed in parallel by the plurality of channels. With this configuration, it is possible to access the memory chips at a transfer rate being multiple times a transfer rate of one channel.

### BRIEF DESCRIPTION OF THE DRAWINGS

FIG. 1 is a schematic diagram illustrating an example of a configuration of a memory system according to an embodiment;

FIG. 2 is a diagram illustrating a configuration example of a memory chip according to the embodiment;

FIG. 3 is a schematic diagram illustrating a more detailed connection relationship between a bridge chip and each memory chip according to the embodiment;

FIG. 4 is a schematic diagram illustrating a connection example in a case where a memory controller according to the embodiment is applied to another memory system;

FIG. 5 is a diagram illustrating an example of a hardware configuration of the memory controller according to the embodiment;

FIG. 6 is a diagram illustrating an example of a hardware configuration of the bridge chip according to the embodiment;

FIG. 7 is a diagram illustrating an example of a function of combining data of a dividing-and-combining circuit according to the embodiment;

FIG. 8 is a diagram illustrating an example of a function of dividing data of the dividing-and-combining circuit according to the embodiment;

FIG. 9 is a schematic diagram illustrating an example of a flow of data in the memory system according to the embodiment;

FIG. 10 is a schematic diagram illustrating an example of settings of the memory controller in a case where the memory controller according to the embodiment is applied to a memory system having a general configuration;

FIG. 11 is a diagram illustrating an example of a list of access requests stored in a buffer memory according to the embodiment;

FIG. 12 is a diagram illustrating an example of a pair acquired by a processor provided in a scheduler according to the embodiment;

FIG. 13 is a flowchart illustrating an example of an operation of the scheduler according to the embodiment;

FIG. 14 is a flowchart illustrating another example of the operation of the scheduler according to the embodiment; and

FIG. 15 is a schematic diagram illustrating another example of the configuration of the memory system according to the embodiment.

### DETAILED DESCRIPTION

According to the present embodiment, a memory system includes a semiconductor memory device and a control device. The semiconductor memory device includes a first device, second devices each including a memory cell array, and first channels connected to the first device. Each of the first channels is connected to one or more of the second devices. The control device includes first circuits and a second circuit. The first circuits are connected to the first device via a second channel. Each of the first circuits is configured to transfer and output data to one of the second devices as an access destination while performing processing related to error suppression on the data. The second circuit is provided between the first circuits and the second channel. The second circuit is configured to combine pieces of data transferred by the first circuits and transfer combined data to the second channel at a transfer rate of n times (n represents an integer) a transfer rate of each piece of pre-combing data. The n is the number of pieces of the pre-combing data. The second circuit is configured to divide data received via the second channel into pieces of data and distribute the pieces of data to m of the first circuits (m represents an integer) at a transfer rate of 1/m times a transfer rate of pre-dividing data. The m is the number of pieces of divided data.

Hereinafter, a memory system, a control device, and a method according to an embodiment will be described in detail with reference to the accompanying drawings. It is noted that the present invention is not limited by the present embodiment.

### Embodiment

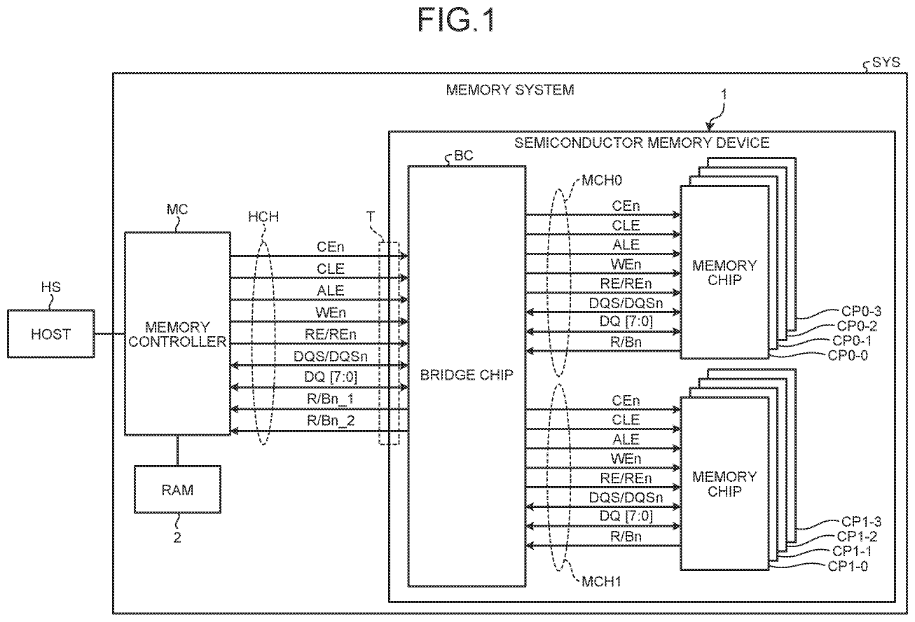

FIG. 1 is a schematic diagram illustrating an example of a configuration of a memory system SYS according to an embodiment.

The memory system SYS can be connected to a host HS. A communication path connecting the host HS to the memory system SYS and a standard with which communication via the communication path is compliant are not limited to a specific standard. The host HS is, for example, a personal computer, a personal digital assistant, a server, etc. When accessing the memory system SYS, the host HS transfers an access command to the memory system SYS. The access command is a write command or a read command, for example.

The memory system SYS includes a semiconductor memory device 1, a memory controller MC, and a random access memory (RAM) 2.

The memory controller MC is a control device that controls the semiconductor memory device 1. As part of the control of the semiconductor memory device 1, the memory controller MC executes data transfer between the host HS and the semiconductor memory device 1 in response to the access command from the host HS.

The RAM 2 provides the memory controller MC with functions such as a buffer area, a cache area, and an area in which a program is loaded. For example, the memory controller MC can buffer transfer data between the host HS and the semiconductor memory device 1 in the RAM 2. In addition, the memory controller MC loads a firmware program into the RAM 2 to use the firmware program, and buffers or caches various management data in the RAM 2.

The semiconductor memory device 1 includes an external terminal group T, a bridge chip BC, and a plurality of memory chips CP0-0 to CP0-3 and CP1-0 to CP1-3. Each of the memory chips CP0-0 to CP0-3 and CP1-0 to CP1-3 is, for example, a memory chip of a nonvolatile memory such as a NAND flash memory. In the present embodiment, it is assumed that each of the memory chips CP0-0 to CP0-3 and CP1-0 to CP1-3 is a memory chip of a NAND flash memory.

The semiconductor memory device 1 can be mounted as a multi-chip package (MCP) in which the memory chips CP0-0 to CP0-3 and the memory chips CP1-0 to CP1-3 are each stacked. When the semiconductor memory device 1 is mounted as the MCP, peripheries of the bridge chip BC and the memory chips CP0-0 to CP0-3 and CP1-0 to CP1-3 in the semiconductor memory device 1 may be sealed by resin molding.

In addition, the semiconductor memory device 1 includes a plurality of channels to connect the memory chips CP0-0 to CP0-3 and CP1-0 to CP1-3 to the bridge chip BC. Each of the channels is referred to as a memory channel MCH in the sense of a channel connected to the NAND flash memory.

In the example of FIG. 1, the semiconductor memory device 1 includes memory channels MCH0 and MCH1 as memory channels MCH. The four memory chips CP0-0 to CP0-3 are connected to the bridge chip BC via the memory channel MCH0, and the four memory chips CP1-0 to CP1-3 are connected to the bridge chip BC via the memory channel MCH1.

Each memory channel MCH is configured on the basis of a predetermined standard. In a case where each of the memory chips CP0-0 to CP0-3 and CP1-0 to CP1-3 is a NAND flash memory, the predetermined standard is, for example, a toggle DDR standard.

It is noted that the number of memory chips CP included in the semiconductor memory device 1 is not limited to eight. In addition, the number of memory channels MCH connecting the bridge chip BC to the memory chips CP is not limited to two.

The bridge chip BC is an example of a first device. Each of the memory chips CP0-0 to CP0-3 and CP1-0 to CP1-3 is an example of a second device. Each of the memory channels MCH is an example of a first channel. Each of the memory channels MCH is also an example of a second channel.

Hereinafter, each of the memory chips CP0-0 to CP0-3 and CP1-0 to CP1-3 may be referred to as a memory chip CP. In addition, each of the memory chips CP0-0 to CP0-3 may be referred to as a memory chip CP0. Each of the memory chips CP1-0 to CP1-3 may be referred to as a memory chip CP1.

The semiconductor memory device 1 is connected to the memory controller MC via a single channel. This single channel is referred to as a host channel HCH in the sense of a channel located on the host side when viewed from the bridge chip BC.

The host channel HCH is configured on the basis of a predetermined standard. In a case where each memory chip CP is a NAND flash memory, the predetermined standard is, for example, a toggle DDR standard.

It is noted that the host channel HCH is an example of a second channel. The host channel HCH is also an example of a first channel.

The host channel HCH includes a signal line that transfers a chip enable signal CEn, a signal line that transfers a command latch signal CLE, a signal line that transfers an address latch signal ALE, a signal line that transfers a write enable signal WEn, a signal line that transfers a read enable signal RE/REn, a signal line that transfers a data strobe signal DQS/DQSn, a signal line that transfers a data signal DQ(7:0) having a predetermined bit width (in one example, an eight-bit width), a signal line that transfers a ready busy signal R/Bn_1, and a signal line that transfers a ready busy signal R/Bn_2. It is noted that “n” written at the end of a reference sign of a signal represents a signal that is operated with negative logic. Such an operation logic can be optionally designed for each signal.

The chip enable signal CEn is a signal for enabling the memory chip CP to be accessed. The data strobe signal DQS/DQSn is a signal instructing a counterpart device to capture data transferred by the data signal DQ(7:0). The data strobe signal DQS/DQSn is a differential signal configured by a data strobe signal DQS and a data strobe signal DQSn. The command latch enable signal CLE is a signal indicating that the data signal DQ(7:0) is a command. The address latch enable signal ALE is a signal indicating that the data signal DQ(7:0) is an address. The write enable signal WEn is a signal instructing the counterpart device to capture the command or the address transferred by the data signal DQ(7:0). The read enable signal RE/REn is a signal instructing the counterpart device to output the data signal DQ(7:0). The read enable signal RE/REn is a differential signal configured by a read enable signal RE and a read enable signal REn. The ready/busy signal R/Bn_1 and the ready/busy signal R/Bn_2 are signals indicating whether the state is a ready state in which the receiving of the command is waited for or a busy state in which the command cannot be executed even if the command is received. It is noted that the configuration of the signal line that transfers the ready/busy signal R/Bn included in the host channel HCH is not limited to the above example. For example, with respect to the ready/busy signal R/Bn, the host channel HCH may include one signal line for transferring one ready/busy signal R/Bn generated by wired OR connection or the like from the ready/busy signal R/Bn related to the memory channel MCH0 and the ready/busy signal R/Bn related to the memory channel MCH1.

Each of the memory channels MCH0 and MCH1 can transfer and receive a signal group of the same type as the signal group of the host channel HCH. That is, each of the memory channels MCH0 and MCH1 includes a signal line that transfers the chip enable signal CEn, a signal line that transfers the command latch signal CLE, a signal line that transfers the address latch signal ALE, a signal line that transfers the write enable signal WEn, a signal line that transfers the read enable signal RE/REn, a signal line that transfers the data strobe signal DQS/DQSn, a signal line group that transfers the data signal DQ(7:0), and a signal line that transfers the ready/busy signal R/Bn.

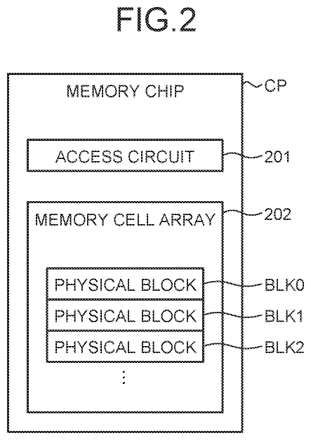

FIG. 2 is a diagram illustrating a configuration example of the memory chip CP according to the embodiment. The memory chip CP includes an access circuit 201 and a memory cell array 202.

The memory cell array 202 includes a plurality of physical blocks BLK (BLK0, BLK1, . . . ). Each physical block BLK is a set of nonvolatile memory cell transistors. Each physical block BLK includes a plurality of storage areas referred to as pages.

The access circuit 201 includes, for example, a row decoder, a column decoder, a sense amplifier, a latch circuit, and a voltage generation circuit. The access circuit 201 executes data writing, data reading, or data erasing on the memory cell array 202 in response to an instruction received from the memory controller MC via the bridge chip BC.

Specifically, the access circuit 201 is able to receive an input of data on the page-by-page basis from the memory controller MC via the bridge chip BC and write the received data on the page-by-page basis into the memory cell array 202. In addition, the access circuit 201 is able to read the data on the page-by-page basis from the memory cell array 202 and output the read data on the page-by-page basis to the memory controller MC via the bridge chip BC for each data having a size smaller than a page called a cluster. In addition, the access circuit 201 is able to execute data erasing on the physical block BLK.

It is noted that the access circuit 201 and the memory cell array 202 may be divided into units referred to as planes that can operate independently of each other.

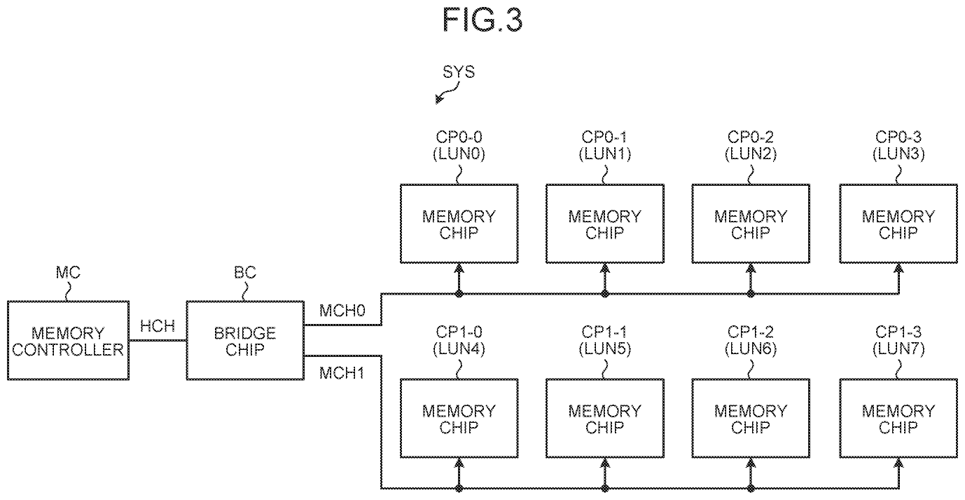

FIG. 3 is a schematic diagram illustrating a more detailed connection relationship between the bridge chip BC and each memory chip CP of the embodiment.

As illustrated in FIG. 3, the four memory chips CP0-0 to CP0-3 are connected to the memory channel MCH0. Similarly, the four memory chips CP1-0 to CP1-3 are connected to the memory channel MCH1.

It is noted that the memory chips CP0-0 to CP0-3 and CP1-0 to CP1-3 may not be connected to all the signal lines constituting the corresponding memory channel MCH. For example, the memory chips CP0-0 to CP0-3 and CP1-0 to CP1-3 may be configured such that part of the signal lines constituting the corresponding memory channel MCH, which is other than the signal line for transferring the data signal DQ(7:0), connects the bridge chip BC and the individual memory chips CP on the one-to-one basis.

Since the bridge chip BC and each memory chip CP are connected as described above, the bridge chip BC can execute data transfer via the memory channel MCH0 and data transfer via the memory channel MCH1 independently of each other. Then, the host channel HCH connecting the memory controller MC and the bridge chip BC is controlled so as to prevent transfer data from being stagnant in the bridge chip BC even when the data transfer via the memory channel MCH0 and the data transfer via the memory channel MCH1 are executed in parallel. Therefore, the host channel HCH can transfer data at a transfer rate obtained by combining a transfer rate of the memory channel MCH0 and a transfer rate of the memory channel MCH1. That is, the host channel HCH can transfer data at a transfer rate twice a transfer rate of the memory channel MCH.

In order to raise the transfer rate of the data transfer between the memory controller MC and the group of the memory chips CP as high as possible, the memory controller MC accesses the memory chips CP0-0 to CP0-3 and CP1-0 to CP1-3 such that an access type, a transfer size, and a transfer timing coincide with each other between the data transfer with one of the four memory chips CP0-0 to CP0-3 as an access destination and the data transfer with one of the four memory chips CP1-0 to CP1-3 as an access destination. It is noted that the access type includes reading (Read) and writing (Write).

Each of the memory chips CP is given, for example, a logical unit number (LUN) that is a unique identification number in the semiconductor memory device 1. In order to implement the above access control, the memory controller MC stores, in advance, a relationship between the LUN given to each memory chip CP and the memory channel MCH to which the memory chip CP is connected. In the example illustrated in FIG. 3, LUN0 is given to the memory chip CP0-0, LUN1 is given to the memory chip CP0-1, LUN2 is given to the memory chip CP0-2, LUN3 is given to the memory chip CP0-3, LUN4 is given to the memory chip CP1-0, LUN5 is given to the memory chip CP1-1, LUN6 is given to the memory chip CP1-2, and LUN7 is given to the memory chip CP1-3. Then, the memory controller MC stores, in advance, that the four memory chips CP (that is, the memory chips CP0-0 to CP0-3) respectively identified by LUN0 to LUN3 are connected to the memory channel MCH0, and the four memory chips CP (that is, the memory chips CP1-0 to CP1-3) respectively identified by LUN4 to LUN7 are connected to the memory channel MCH1.

As a general memory system, a memory system in which a memory chip is connected to a memory controller without a bridge chip has been known. For a manufacturer who manufactures a memory controller mounted on the general memory system, newly designing a memory controller dedicated to a system to which a bridge chip is applied requires a large amount of labor for designing and a large burden also in terms of costs. Therefore, it is desirable to be able to mount a memory system to which a bridge chip is applied only by a slight design change with respect to a memory controller that can be mounted on a general memory system.

In addition, it is desirable that the memory controller can be mounted on both the general memory system and the memory system to which the bridge chip is applied without a design change or with only a slight design change.

The memory controller MC of the embodiment has a suitable configuration obtained by a slight design change with respect to a memory controller mounted on a general memory system.

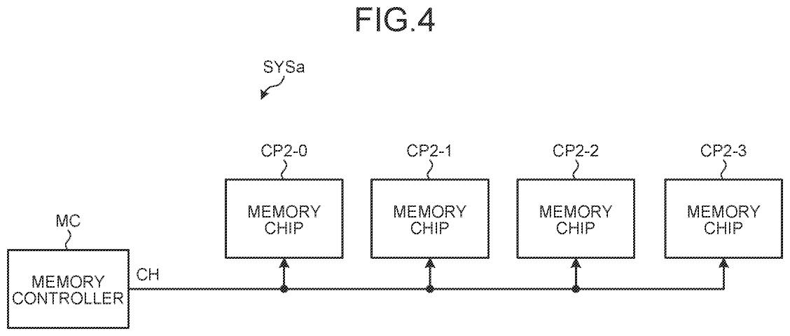

Moreover, the memory controller MC of the embodiment is configured such that the memory chip CP can be connected thereto without the bridge chip BC, as illustrated in FIG. 4, for example, by slightly changing the setting. In the example illustrated in FIG. 4, the memory controller MC of the embodiment is mounted in a memory system SYSa without the bridge chip BC. Then, memory chips CP2-0 to CP2-3 are connected to the memory controller MC via a channel CH. The channel CH has, for example, a configuration similar to that of the host channel HCH or the memory channel MCH.

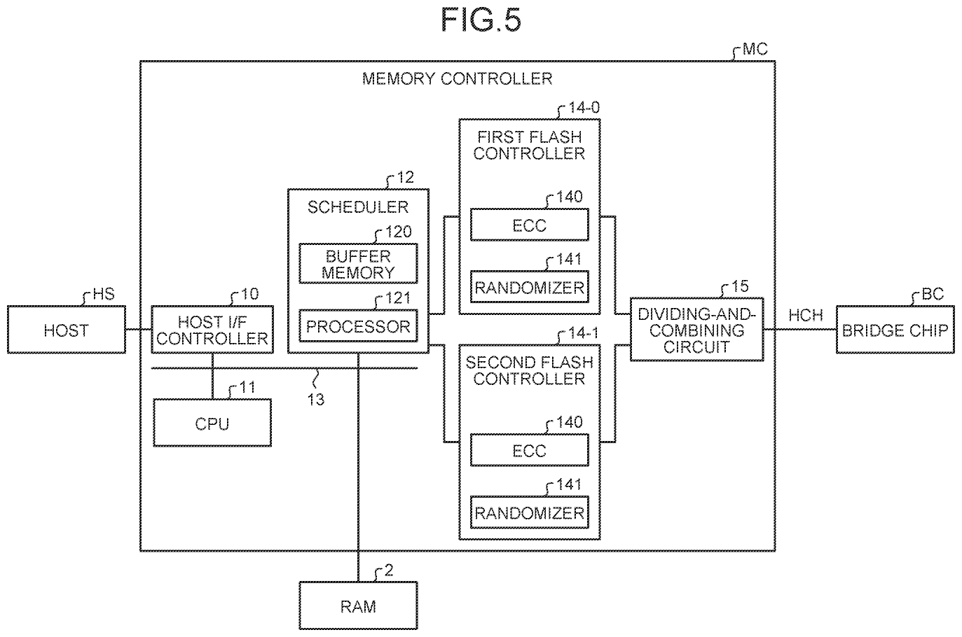

FIG. 5 is a diagram illustrating an example of a hardware configuration of the memory controller MC according to the embodiment.

The memory controller MC includes a host interface controller (host OF controller) 10, a central processing unit (CPU) 11, a scheduler 12, a bus 13, a first flash controller 14-0, a second flash controller 14-1, and a dividing-and-combining circuit 15. It is noted that the first flash controller 14-0 and the second flash controller 14-1 may each be referred to as a flash controller 14.

The host OF controller 10, the CPU 11, the RAM 2, and the scheduler 12 are electrically connected to the bus 13.

In one example, the memory controller MC is configured as a system-on-a-chip (SoC). The memory controller MC may include a plurality of chips. The memory controller MC may be configured as one SoC including the RAM 2.

Each of the flash controllers 14 is an example of a first circuit. The dividing-and-combining circuit 15 is an example of a second circuit. The CPU 11 is an example of a third circuit. The scheduler 12 is an example of a fourth circuit.

The host OF controller 10 executes control of signal transfer to/from the host HS. For example, the host OF controller 10 receives various commands from the host HS. In addition, the host OF controller 10 transfers data to the host HS.

The CPU 11 is a processor that executes control of the entire memory controller MC. The CPU 11 executes the control based on a firmware program. As part of the control, the CPU 11 identifies an access destination in the semiconductor memory device 1 on the basis of address information included in an access command from the host HS. Then, the CPU 11 generates an access request that is a request for access to the identified access destination. The access request includes address information indicating an access destination, designation of an access type, and designation of a size of transfer data.

The flash controllers 14 each control, on the basis of the access request generated by the CPU 11, data transfer that is addressed to one memory chip CP as an access destination and is performed between the memory controller MC and the semiconductor memory device 1. The flash controllers 14 each execute, to the memory chip CP serving as the access destination designated by the access request, transfer of data of the access type designated by the access request and the size designated by the access request.

In addition, the flash controllers 14 each perform various types of processing related to error suppression on the transfer data. In one example, various types of processing related to the error suppression include error correction coding, error correction, randomization processing, and reverse processing of the randomization processing.

Each of the flash controller 14 includes an error correction code (ECC) circuit 140 and a randomizer 141.

The ECC circuit 140 performs error correction coding on data to be transferred to the semiconductor memory device 1 on the cluster-by-cluster basis. In addition, the ECC circuit 140 performs error correction on data received from the semiconductor memory device 1 on the cluster-by-cluster basis.

The randomizer 141 executes randomization processing of equalizing the appearance frequency of “0” and the appearance frequency of “1” on the data to be transferred to the semiconductor memory device 1. In addition, the randomizer 141 executes reverse processing of the randomization processing on the data received from the semiconductor memory device 1, thereby restoring the data to a state before the randomization processing is performed.

The scheduler 12 includes a buffer memory 120 and a processor 121. The buffer memory 120 sequentially receives access requests generated by the CPU 11. When the number of access requests accumulated in the buffer memory 120 becomes two or more, the processor 121 acquires, from the two or more access requests, a pair of access requests consisting of: an access request to one of the four memory chips CP0-0 to CP0-3 as an access destination, and an access request to one of the four memory chips CP1-0 to CP1-3 as an access destination. The processor 121 obtains, as the pair, two access requests having a common access type and transfer size. The processor 121 simultaneously inputs one access request of the pair of access requests to the first flash controller 14-0 and inputs the other access request of the pair of access requests to the second flash controller 14-1.

The scheduler 12 correlates the two memory channels MCH with the two flash controllers 14 on the one-to-one basis. Then, the scheduler 12 inputs one access request of the pair of two access requests to the flash controller 14 corresponding to the memory channel MCH that is connected the memory chip CP and designated as an access destination by the access request. In addition, the scheduler 12 inputs the other one access request of the pair of access requests to the flash controller 14 corresponding to the memory channel MCH that is connected to the memory chip CP and designated as an access destination by the access request.

An one example, it is assumed that the memory channel MCH0 is correlated with the first flash controller 14-0 and the memory channel MCH1 is correlated with the second flash controller 14-1. It is noted that correspondence between the two memory channels MCH and the two flash controllers 14 is not necessarily fixed. The correspondence between the two memory channels MCH and the two flash controllers 14 may be dynamically changed.

When access requests of the pair are simultaneously input to the two flash controllers 14, the flash controllers 14 simultaneously start respective data transfer to the memory chip CP serving as an access destination based on the respective access requests.

The dividing-and-combining circuit 15 is provided between the two flash controllers 14 and the host channel HCH.

When pieces of transfer data are input in parallel from the first flash controller 14-0 and the second flash controller 14-1, the dividing-and-combining circuit 15 combines the pieces of transfer data input from the first flash controller 14-0 and the second flash controller 14-1, and transfers combined transfer data to the bridge chip BC via the host channel HCH at a transfer rate twice a transfer rate of the memory channel MCH.

In addition, when data obtained by combining data output from one of the four memory chips CP0-0 to CP0-3 and data output from one of the four memory chips CP1-0 to CP1-3 is received at a transfer rate twice that of the memory channel MCH via the host channel HCH, the dividing-and-combining circuit 15 divides the received data into two. Then, the dividing-and-combining circuit 15 transfers one of the two-divided data to the first flash controller 14-0 at the same transfer rate as that of the memory channel MCH, and transfers the other of the two-divided data to the second flash controller 14-1 at the same transfer rate as that of the memory channel MCH.

It is noted that part of or all the functions of the CPU 11 may each be implemented by a hardware circuit such as a field-programmable gate array (FPGA) or an application specific integrated circuit (ASIC). Moreover, part of or all the functions of the scheduler 12 may each be implemented by the CPU 11 executing the firmware program.

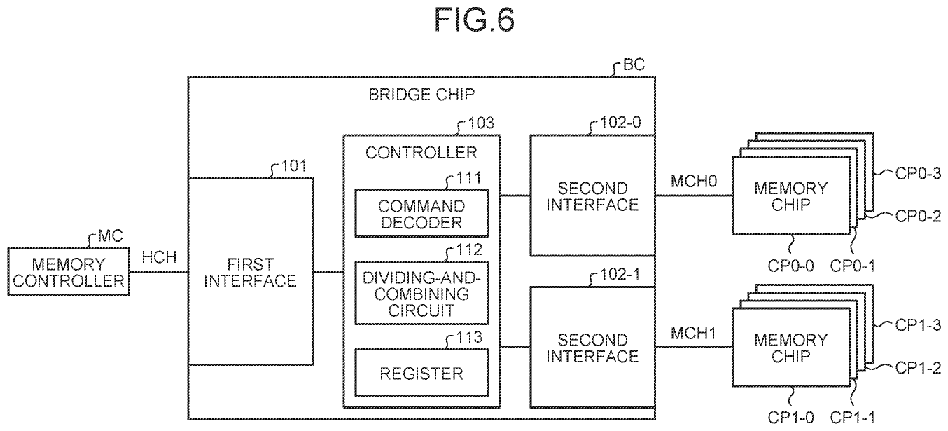

FIG. 6 is a diagram illustrating an example of a hardware configuration of the bridge chip BC according to the embodiment.

The bridge chip BC includes a first interface 101, two second interfaces 102 (102-0, 102-1), and a controller 103.

The first interface 101 is a PHY circuit that transfers and receives a signal to and from the memory controller MC via the host channel HCH.

The second interface 102-0 of the two second interfaces 102 is a PHY circuit that transfers and receives a signal to and from the four memory chips CP0-0 to CP0-3 via the memory channel MCH0. The second interface 102-1 of the two second interfaces 102 is a PHY circuit that transfers and receives a signal to and from the four memory chips CP1-0 to CP1-3 via the memory channel MCH1.

The controller 103 is provided between the first interface 101 and the two second interfaces 102. The controller 103 controls exchange of information between the first interface 101 and the two second interfaces 102.

The controller 103 includes a command decoder 111, a dividing-and-combining circuit 112, and a register 113.

The command decoder 111 analyzes a command received from the memory controller MC via the host channel HCH. The command decoder 111 can issue a command to the memory chip CP according to the analysis result.

The register 113 is a memory that stores various types of information for controlling the operation of the bridge chip BC.

When data output from one of the four memory chips CP0-0 to CP0-3 and data output from one of the four memory chips CP1-0 to CP1-3 are simultaneously input from the two second interfaces 102, the dividing-and-combining circuit 112 combines the two pieces of output data. The dividing-and-combining circuit 112 supplies combined data to the first interface 101 at a transfer rate twice a transfer rate of the memory channel MCH. The first interface 101 transfers the combined data to the memory controller MC via the host channel HCH at a transfer rate twice the transfer rate of the memory channel MCH.

In addition, when data obtained by combining data addressed to one of the four memory chips CP0-0 to CP0-3 as a transferring destination and data addressed to one of the four memory chips CP1-0 to CP1-3 as a transferring destination is received at a transfer rate twice the transfer rate of the memory channel MCH via the host channel HCH and the first interface 101, the dividing-and-combining circuit 112 divides the received data into two. Then, the dividing-and-combining circuit 15 transfers one of the two-divided data to the second interface 102-0 at the same transfer rate as that of the memory channel MCH, and transfers the other of the two-divided data to the second interface 102-1 at the same transfer rate as that of the memory channel MCH.

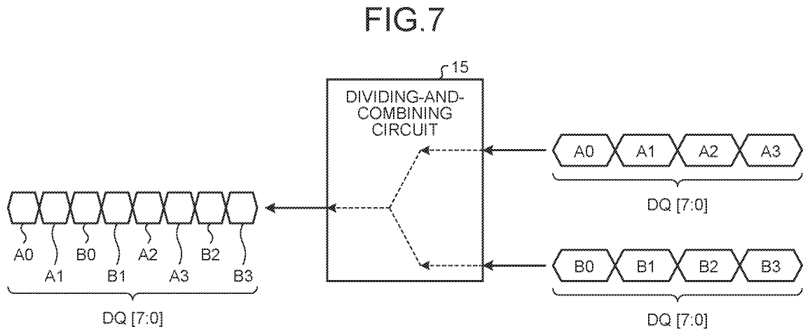

FIG. 7 is a diagram illustrating an example of a function of combining pieces of data by the dividing-and-combining circuits 15 and 112 of the embodiment. The dividing-and-combining circuit 15 and the dividing-and-combining circuit 112 have the same function. Here, the dividing-and-combining circuit 15 is illustrated as a representative of those dividing-and-combining circuits 15 and 112, and its function will be described.

FIG. 7 illustrates a combining method for a case where a data string of one-byte data A0, data A1, data A2, and data A3 is input to the dividing-and-combining circuit 15, and, simultaneously, a data string of one-byte data B0, data B1, data B2, and data B3 is input thereto. In this case, the dividing-and-combining circuit 15 alternately acquires data by two bytes from the input two data strings, and sequentially combines the acquired two-byte data in the order of acquisition. As a result, the dividing-and-combining circuit 15 generates a data string in which the data A0, the data A1, the data B0, the data B1, the data A2, the data A3, the data B2, and the data B3 are arranged in this order. Then, the dividing-and-combining circuit 15 outputs the generated data string of the data A0, the data A1, the data B0, the data B1, the data A2, the data A3, the data B2, and the data B3.

The dividing-and-combining circuit 15 outputs one data string generated by combining the two data strings at a transfer frequency twice a transfer frequency of each data string when the two data strings are simultaneously input thereto. Each of the two data strings is input to the dividing-and-combining circuit 15 at the same transfer rate as the transfer rate of the memory channel MCH. Therefore, the dividing-and-combining circuit 15 outputs one data string generated by combining the two data strings at a transfer rate twice the transfer rate of the memory channel MCH.

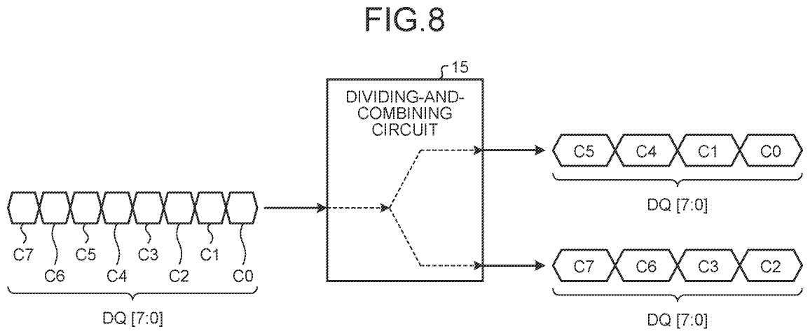

FIG. 8 is a diagram illustrating an example of a function of dividing data by the dividing-and-combining circuits 15 and 112 of the embodiment. Here, the dividing-and-combining circuit 15 is also illustrated as a representative of the dividing-and-combining circuits 15 and 112, and its function will be described.

FIG. 8 illustrates a division method for a case where a data string of one-byte data C0, data C1, data C2, data C3, data C4, data C5, data C6, and data C7 is input to the dividing-and-combining circuit 15. In this case, the dividing-and-combining circuit 15 acquires data by two bytes from the input data string and alternately distributes the acquired data of two bytes to two paths. As a result, the dividing-and-combining circuit 15 generates, from the input data string of the data C0, the data C1, the data C2, the data C3, the data C4, the data C5, the data C6, and the data C7, two data strings including a data string of the data C0, the data C1, the data C4, and the data C5, and a data string of the data C2, the data C3, the data C6, and the data C7, and outputs the generated two data strings.

The dividing-and-combining circuit 15 outputs each of the two data strings generated by the division at a transfer frequency half a transfer frequency of the input one data string. One data string is input to the dividing-and-combining circuit 15 at a transfer rate twice the transfer rate of the memory channel MCH. Therefore, the dividing-and-combining circuit 15 outputs each of the two data strings generated by the division at the same transfer rate as the transfer rate of the memory channel MCH.

It is noted that the method of combining the data strings and the method of dividing the data strings by the dividing-and-combining circuits 15 and 112 are not limited to the examples described above.

For example, the dividing-and-combining circuits 15 and 112 may convert each of two pieces of transfer data each having an eight-bit width input from two channels into transfer data having a four-bit width, combine the converted two pieces of transfer data having a four-bit width, and output the integrated transfer data having an eight-bit width to one channel at a transfer frequency twice a transfer frequency before the combining.

When the transfer data having an eight-bit width is received from one channel, the dividing-and-combining circuits 15 and 112 divide the transfer data having an eight-bit width into two pieces of transfer data each having a four-bit width. Then, the dividing-and-combining circuits 15 and 112 may convert each of the two temporally-consecutive transfer data each having a four-bit width into transfer data having an eight-bit width, and output each of the two converted transfer data each having an eight-bit width to two channels at a transfer frequency half that of pre-dividing transfer data (i.e., transfer data before the dividing).

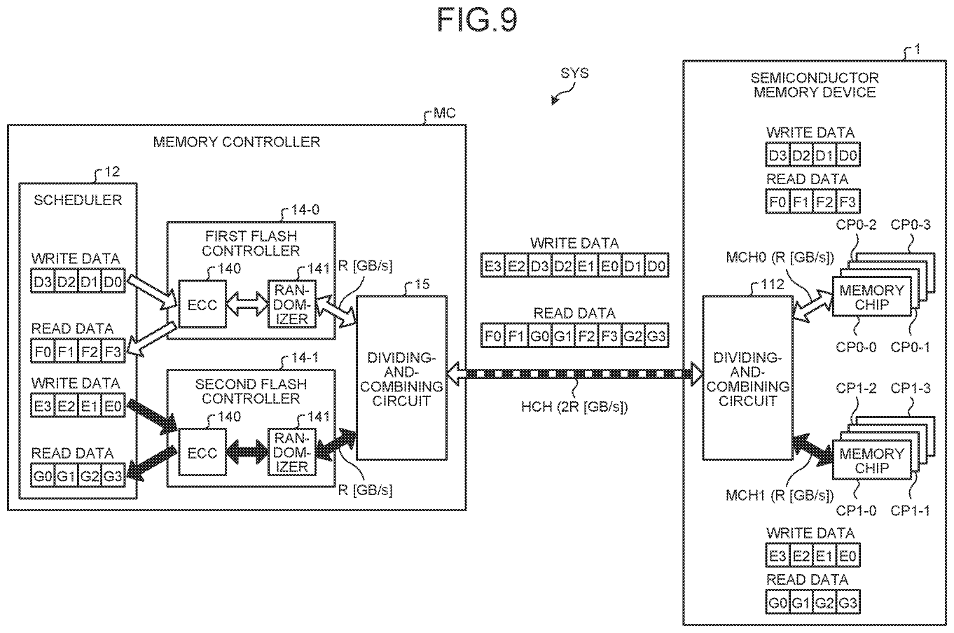

FIG. 9 is a schematic diagram illustrating an example of a flow of data in the memory system SYS of the embodiment.

In FIG. 9, illustration of some of the components included in the memory system SYS are omitted. In addition, a blanked (or white) arrow indicates data transfer addressed to the memory chip CP0 as an access destination connected to the memory channel MCH0, and a filled (or black) arrow indicates data transfer addressed to the memory chip CP1 as an access destination connected to the memory channel MCH1. A stripe hatched (or black/white) arrow indicates data transfer of data obtained by combining transfer data addressed to the memory chip CP0 as an access destination connected to the memory channel MCH0 and transfer data addressed to the memory chip CP1 as an access destination connected to the memory channel MCH1. In addition, the transfer rate of the memory channel MCH is set to R (GB/s). Therefore, when one data string obtained by combining two data strings is transferred on the host channel HCH, the transfer rate on the host channel HCH is 2R (GB/s).

For example, when a write request of a data string of data DO, data D1, data D2, and data D3, which is designated by the memory chip CP0 connected to the memory channel MCH0 as a write destination, and a write request of a data string of data E0, data E1, data E2, and data E3, which is designated by the memory chip CP1 connected to the memory channel MCH1 as a write destination, are stored in the buffer memory 120, the scheduler 12 inputs the write request of the data string of the data DO, the data D1, the data D2, and the data D3 to the first flash controller 14-0, and simultaneously inputs the write request of the data string of the data E0, the data E1, the data E2, and the data E3 to the second flash controller 14-1.

The first flash controller 14-0 acquires the data string of the data DO, the data D1, the data D2, and the data D3 in response to the input write request. Specifically, the data string of the data DO, the data D1, the data D2, and the data D3 is acquired in advance from the host HS to the memory system SYS by the host OF controller 10, and the acquired data string is stored in a buffer area in the RAM 2. The first flash controller 14-0 acquires the data string of the data DO, the data D1, the data D2, and the data D3 from the buffer area via the scheduler 12 in response to the write request. Then, the first flash controller 14-0 executes error correction coding by the ECC circuit 140 and executes randomization processing by the randomizer 141. Then, the first flash controller 14-0 outputs the data string of the data DO, the data D1, the data D2, and the data D3 at R (GB/s) after performing various types of processing on the data string.

Similarly to the first flash controller 14-0, the second flash controller 14-1 acquires the data string of the data E0, the data E1, the data E2, and the data E3 stored in advance in the buffer area from the buffer area via the scheduler 12 in response to the write request. Then, the second flash controller 14-1 executes error correction coding by the ECC circuit 140 on the acquired data string of the data E0, the data E1, the data E2, and the data E3, and executes randomization processing by the randomizer 141. Then, the second flash controller 14-1 outputs the data string of the data E0, the data E1, the data E2, and the data E3 at R (GB/s) after performing various types of processing on the data string.

Input of the data string of the data DO, the data D1, the data D2, and the data D3 to the dividing-and-combining circuit 15 after various types of processing and input of the data string of the data E0, the data E1, the data E2, and the data E3 to the dividing-and-combining circuit 15 after various types of processing are simultaneously performed. The dividing-and-combining circuit 15 generates a data string of the data DO, the data D1, the data E0, the data E1, the data D2, the data D3, the data E2, and the data E3 by combining the two data strings that were simultaneously input, and outputs the generated data string at a transfer rate of 2R (GB/s).

The data string generated by the dividing-and-combining circuit 15 is transferred through the host channel HCH at a transfer rate of 2R (GB/s), and restored to the two data strings before combination thereof in the dividing-and-combining circuit 112, and each of the restored two data strings is output at a transfer rate of R (GB/s). The data string of the data DO, the data D1, the data D2, and the data D3 in the restored two data strings is transferred to the memory chip CP0 as a write destination via the memory channel MCH0. The data string of the data E0, the data E1, the data E2, and the data E3 in the restored two data strings is transferred to the memory chip CP1 as a write destination via the memory channel MCH1.

When a read request of a data string of data F0, data F1, data F2, and data F3 stored in the memory chip CP0 connected to the memory channel MCH0 and a read request of a data string of data G0, data G1, data G2, and data G3 stored in the memory chip CP1 connected to the memory channel MCH1 are stored in the buffer memory 120, the scheduler 12 inputs the read request of the data string of the data F0, the data F1, the data F2, and the data F3 to the first flash controller 14-0, and simultaneously inputs the read request of the data string of the data G0, the data G1, the data G2, and the data G3 to the second flash controller 14-1.

In response to the read request, the first flash controller 14-0 prompts the memory chip CP0 that stores the data string of the data F0, the data F1, the data F2, and the data F3 to output the data string of the data F0, the data F1, the data F2, and the data F3. The memory chip CP0 prompted to output the data string thereof outputs the data string of the data F0, the data F1, the data F2, and the data F3.

In response to the read request, the second flash controller 14-1 prompts the memory chip CP1 in which the data string of the data G0, the data G1, the data G2, and the data G3 has been stored to output the data string of the data G0, the data G1, the data G2, and the data G3. Then, the memory chip CP1 outputs the data string of the data G0, the data G1, the data G2, and the data G3.

The data string of the data F0, the data F1, the data F2, and the data F3 is transferred through the memory channel MCH0 at a transfer rate of R (GB/s) and input to the dividing-and-combining circuit 112. At the same time, the data string of the data G0, the data G1, the data G2, and the data G3 is transferred through the memory channel MCH1 at a transfer rate of R (GB/s) and input to the dividing-and-combining circuit 112.

The dividing-and-combining circuit 112 combines the input two data strings to generate a data string of the data F0, the data F1, the data G0, the data G1, the data F2, the data F3, the data G2, and the data G3, and outputs the generated data string at a transfer rate of 2R (GB/s).

The data string output from the dividing-and-combining circuit 112 is transferred through the host channel HCH at a transfer rate of 2R (GB/s), and restored to the two data strings before combination thereof in the dividing-and-combining circuit 15, and each of the restored two data strings is output at a transfer rate of R (GB/s). The data string of the data F0, the data F1, the data F2, and the data F3 of the restored two data strings is input to the first flash controller 14-0 at a transfer rate of R (GB/s). The data string of the data G0, the data G1, the data G2, and the data G3 of the restored two data strings is input to the second flash controller 14-1 at a transfer rate of R (GB/s).

In the first flash controller 14-0, reverse processing of randomization processing by the randomizer 141 and error correction by the ECC circuit 140 are executed on the data string of the data F0, the data F1, the data F2, and the data F3. The first flash controller 14-0 then stores the data string of the data F0, the data F1, the data F2, and the data F3 in the buffer area of the RAM 2 via the scheduler 12 after performing various types of processing on the data string.

Similarly to the first flash controller 14-0, in the second flash controller 14-1, reverse processing of randomization processing by the randomizer 141 and error correction by the ECC circuit 140 are executed on the data string of the data G0, the data G1, the data G2, and the data G3. Then, the second flash controller 14-1 stores the data string of the data G0, the data G1, the data G2, and the data G3 after various processing in the buffer area in the RAM 2 via the scheduler 12.

Here, a technique to be compared with the embodiment will be described. The technique to be compared with the present embodiment is referred to as a comparative example. According to the comparative example, a memory controller includes one flash controller for one host channel. In this case, the flash controller is required to have specifications capable of processing data at a transfer rate obtained by multiplying a transfer rate of a memory channel by the number of memory channels. In the comparative example, a memory controller of a memory system having a general configuration cannot be used. Therefore, a manufacturer is required to newly design a flash controller having the above-described specifications.

Additionally, in the comparative example, the flash controller performs error correction coding and error correction on one data string obtained by multiple data strings are combined. Therefore, the manufacturer is required to redesign the unit of data to be handled in the ECC circuit and a firmware program of the flash controller in order to change the size of a frame for error correction coding and error correction.

In addition, error correction coding is performed in a state where data strings are combined into one, and the one data string subjected to the error correction coding is divided into data strings and stored in memory chips CP having different connection destination memory channels MCH in a distributed manner. When the data string is required to be read again due to failure of error correction in the ECC circuit or the like, it is necessary to redesign the firmware program so that the data string can be read from all the memory chips CP.

Moreover, regarding the randomizer in the comparative example, the manufacturer needs to newly design the firmware program not only to simply improve the operation speed but also to execute randomization processing such that the appearance frequency of “0” and the appearance frequency of “1” are guaranteed to be equal in each divided data string for one data string obtained by combining data strings.

In contrast to the comparative example above, the memory controller MC according to the present embodiment includes, with respect to one host channel HCH, a sufficient number of flash controllers 14 capable of handling the number of memory channels MCH and the dividing-and-combining circuit 15. The dividing-and-combining circuit 15 combines transfer data output from the flash controllers 14 having the number thereof corresponding to the number of memory channels MCH, or divides transfer data received via the host channel HCH and distributes the divided transfer data to the flash controllers 14 having the number thereof corresponding to the number of memory channels MCH. Therefore, each flash controller 14 is simply required to have specifications capable of executing each of error correction coding, error correction, randomization processing, and reverse processing of randomization processing on data at the same transfer rate as the transfer rate of the memory channel MCH.

In addition, according to the embodiment, each flash controller 14 performs the error correction coding, the error correction, the randomization processing, and the reverse processing of the randomization processing on pre-combining transfer data addressed to one memory chip CP as an access destination. Therefore, in a case where a memory system having a general configuration that a memory chip is connected to a memory controller without passing through a bridge chip is already designed, a manufacturer can directly use a flash controller applied in the general memory system as the flash controller 14 of the embodiment.

In addition, each of the flash controllers 14 performs processing on a data string of transfer data that are not yet combined into one data string and that are addressed to one memory chip CP as an access destination. Therefore, a firmware program applied in the general memory system can be applied to the memory system of the embodiment without significant modification.

Accordingly, the memory system SYS of the embodiment has a suitable configuration that can be applied as the memory controller MC of the embodiment mounted on the memory system SYS to which the bridge chip BC is applied by only a slight design change with respect to the memory controller capable of being mounted on the general memory system.

It is noted that, as described with reference to FIG. 4, the memory controller MC of the embodiment can also be connected to the memory chip CP without the bridge chip BC.

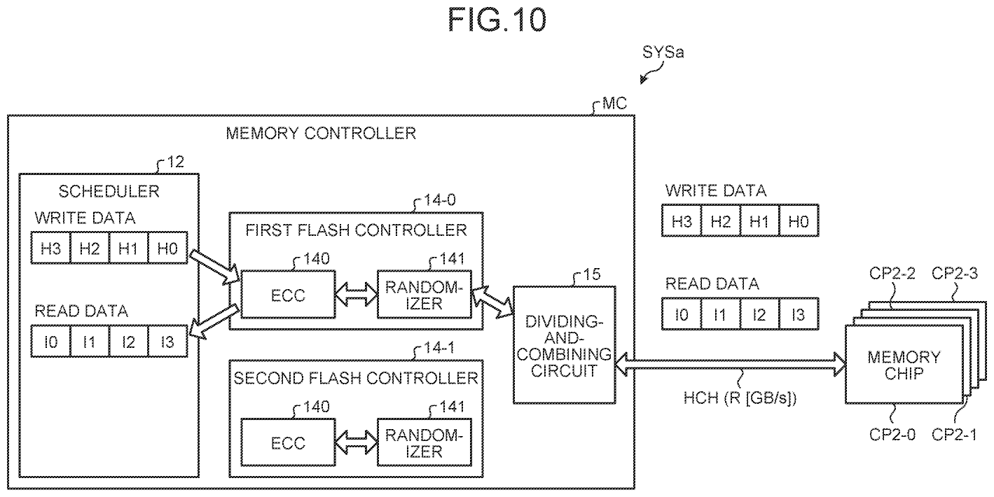

FIG. 10 is a schematic diagram illustrating an example of settings of a memory controller MC in a case where the memory controller MC of the embodiment is applied to a memory system SYSa having a general configuration. In the example illustrated in the drawing, a first flash controller 14-0 is set to be operable, and a second flash controller 14-1 is set not to operate. The dividing-and-combining circuit 15 is set to output an input data string as it is without changing a transfer rate.

When a write request for a data string of data H0, data H1, data H2, and data H3, in which the memory chip CP2 connected to the host channel HCH is designated as a write destination, is stored in the buffer memory 120, the scheduler 12 inputs this write request to the first flash controller 14-0.

The first flash controller 14-0 acquires the data string of the data H0, the data H1, the data H2, and the data H3 in response to the write request. Specifically, the data string of the data H0, the data H1, the data H2, and the data H3 is acquired in advance from the host HS to the memory system SYSa by the host I/F controller 10 and stored in the buffer area in the RAM 2. The first flash controller 14-0 acquires the data string of the data H0, the data H1, the data H2, and the data H3 from the buffer area via the scheduler 12 in response to the write request. Then, the first flash controller 14-0 executes error correction coding using the ECC circuit 140 and randomization processing using the randomizer 141. Then, the first flash controller 14-0 outputs the data string of the data H0, the data H1, the data H2, and the data H3 at R (GB/s) after performing various types of processing on the data string.

The data string of the data H0, the data H1, the data H2, and the data H3 output from the first flash controller 14-0 is input to the dividing-and-combining circuit 15 at a transfer rate of R (GB/s). The dividing-and-combining circuit 15 outputs the data string of the data H0, the data H1, the data H2, and the data H3 at a transfer rate of R (GB/s).

The data string of the data H0, the data H1, the data H2, and the data H3 output from the dividing-and-combining circuit 15 is transferred through the host channel HCH at a transfer rate of R (GB/s) and input to the memory chip CP2 designated as a write destination.

In addition, for example, when a read request of a data string of data I0, data Il, data I2, and data I3 held in the memory chip CP2 connected to the host channel HCH is stored in the buffer memory 120, the scheduler 12 inputs the read request to the first flash controller 14-0.

The first flash controller 14-0 controls the memory chip CP2 holding the data string of the data I0, the data I1, the data I2, and the data I3 in response to the read request, and prompts the memory chip CP2 to output the data string of the data I0, the data I1, the data I2, and the data I3. The memory chip CP2 then outputs the data string of the data I0, the data I1, the data I2, and the data I3.

The data string of the data I0, the data I1, the data I2, and the data I3 is transferred through the host channel HCH at a transfer rate of R (GB/s) and input to the dividing-and-combining circuit 15. The dividing-and-combining circuit 15 inputs the data string of the data I0, the data I1, the data I2, and the data I3 to the first flash controller 14-0 at a transfer rate of R (GB/s).

In the first flash controller 14-0, reverse processing of randomization processing by the randomizer 141 and error correction by the ECC circuit 140 are executed on the data string of the data I0, the data I1, the data I2, and the data I3. Then, the first flash controller 14-0 stores the data string of the data I0, the data I1, the data I2, and the data I3 in the buffer area of the RAM 2 via the scheduler 12 after performing various types of processing on the data string.

Each of the flash controllers 14 included in the memory controller MC according to the embodiment is configured to perform error correction coding, error correction, randomization processing, and reverse processing of the randomization processing on pre-combining transfer data in which one memory chip CP is set as an access destination. Therefore, as illustrated in FIG. 10, a manufacturer can also apply the memory controller MC to a system including no bridge chip BC, by setting only one of the flash controllers 14 (14-0) in the memory controller MC to be operable.

Accordingly, the memory controller MC has a suitable configuration capable of being applied to the memory system SYSa with a very slight change.

Next, details of the scheduler 12 according to the embodiment will be described.

Access requests generated by the CPU 11 are sequentially stored in the buffer memory 120 included in the scheduler 12.

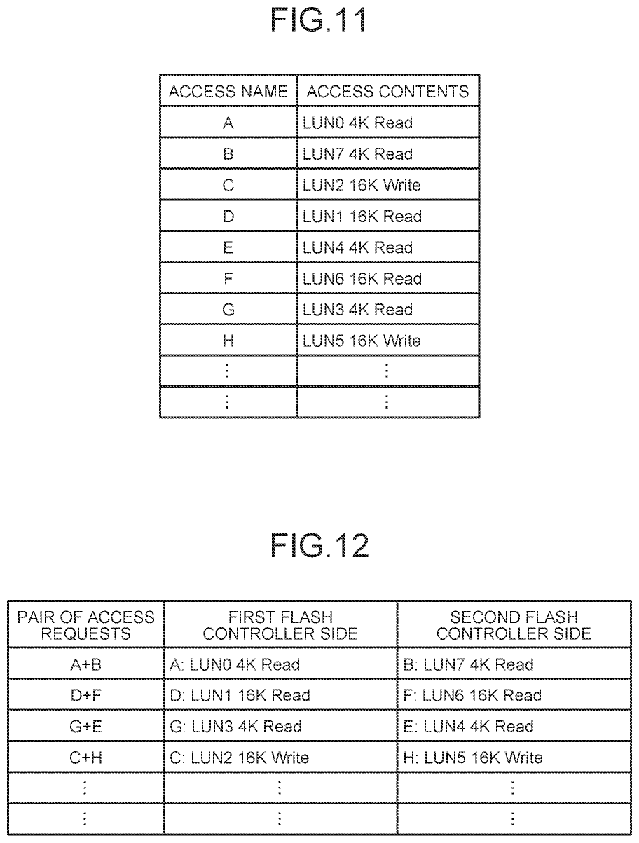

FIG. 11 is a diagram illustrating an example of a list of access requests stored in the buffer memory 120 according to the embodiment. In the drawing, a pair of an access name and an access content is drawn for each access request. It is noted that the access name is an ID of the access request. The access content includes LUN of the memory chip CP serving as an access destination, a size of transfer data, and an access type. In FIG. 11 and FIG. 12 illustrated later, an access request given “X” as the access name is referred to as an access request #X.

As described above, the processor 121 included in the scheduler 12 acquires, from two or more access requests stored in the buffer memory 120, an access request addressed to one of the four memory chips CP0-0 to CP0-3 as an access destination and an access request addressed to one of the four memory chips CP1-0 to CP1-3 as an access destination in pairs.

FIG. 12 is a diagram illustrating an example of a pair acquired by the processor 121 included in the scheduler 12 according to the embodiment.

For example, the processor 121 acquires a pair of an access request #A and an access request #B from the buffer memory 120. The access request #A represents that the memory chip CP0-0 as LUN0 connected to the memory channel MCH0 is designated as an access destination, the designated size of the transfer data is 4 (KB), and the designated access type is Read. The transfer data size and the access type designated for the access request #B are common to the access request #A. The access request #B represents that the memory chip CP1-3 as LUN 7 connected to the memory channel MCH1 is designated as an access destination. Then, the processor 121 inputs the access request #A to the first flash controller 14-0, and inputs the access request #B to the second flash controller 14-1.

Similarly, the processor 121 sequentially acquires, as a pair, two access requests in which the designated size of transfer data and the designated access type are common to each other and the memory channel MCH to which the designated memory chip CP as the access destination is connected is different. Then, the processor 121 inputs, to the first flash controller 14-0, one access request of the acquired pair in which the memory channel MCH to which the designated memory chip CP as the access destination is connected is the memory channel MCH0, and inputs, to the second flash controller 14-1, the other access request in which the memory channel MCH to which the designated memory chip CP as the access destination is connected is the memory channel MCH1.

In the example illustrated in FIG. 12, after the pair of the access request #A and the access request #B is acquired, the processor 121 acquires a pair of an access request #D and an access request #F, a pair of an access request #G and an access request #E, and a pair of an access request #C and an access request #H in this order, and inputs each of the pairs of access requests to the first flash controller 14-0 or the second flash controller 14-1.

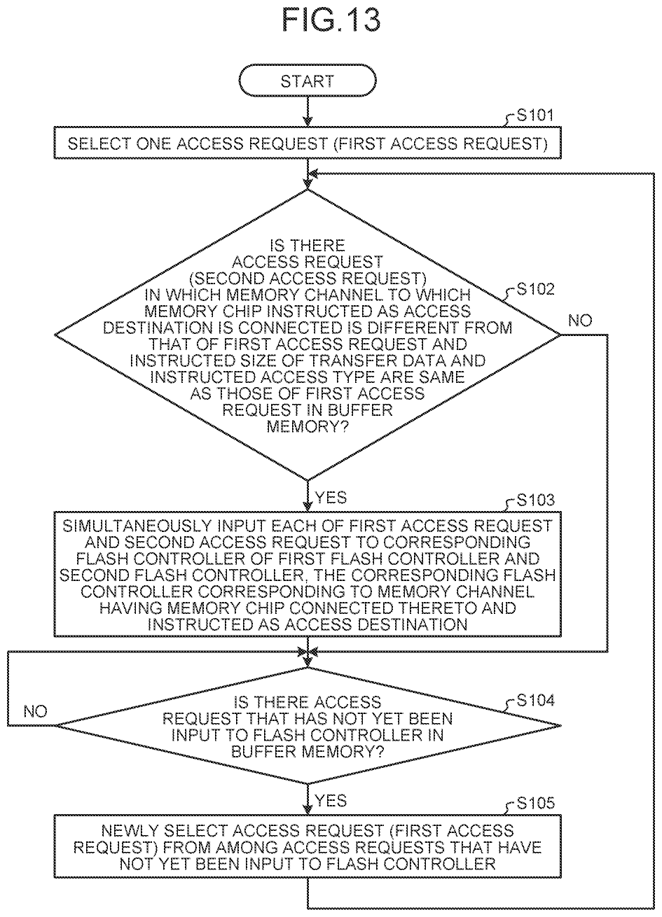

FIG. 13 is a flowchart illustrating an example of the operation of the scheduler 12 according to the embodiment. Here, description of the operation of storing the access request in the buffer memory 120 is omitted. It is assumed that, when an access request is generated by the CPU 11, the access request is stored in the buffer memory 120 asynchronously with a series of operations illustrated in FIG. 13.

First, the processor 121 selects one access request from among one or more access requests stored in the buffer memory 120 (S101). The selected one access request is referred to as a first access request.

Subsequently, the processor 121 determines whether or not there is one access request representing that the memory channel MCH to which the memory chip CP designated as an access destination is connected is different from that of the first access request and the designated size of the transfer data and the designated access type are the same as those of the first access request in the buffer memory 120 (S102). The access request in which the memory channel MCH is different from that of the first access request and the designated size of the transfer data and the designated access type are the same as those of the first access request is referred to as a second access request.

In response determining that there is the second access request in the buffer memory 120 (S102: Yes), the processor 121 simultaneously inputs each of the first access request and the second access request to a corresponding flash controller 14 of the first flash controller 14-0 and the second flash controller 14-1, the corresponding flash controller 14 corresponding to the memory channel MCH having the memory chip CP connected thereto and designated as an access destination (S103).

In response determining that there is not the second access request in the buffer memory 120 (S102: No), or after S103, the processor 121 determines whether there is an access request, which has not yet been input to the flash controller 14, in the buffer memory 120 (S104).

When there is an access request that has not yet been input to the flash controller 14 in the buffer memory 120 (S104: Yes), the processor 121 newly selects an access request from among the access requests that have not yet been input to the flash controller 14 (S105). Then, the processor 121 repeats the operation from S102 using the access request selected in S105 as the first access request.

When there is no access request that has not yet been input to the flash controller 14 in the buffer memory 120 (S104: No), the processor 121 executes the determination processing in S104 again. As a result, the processor 121 postpones the execution of the processing in S105 until an access request is newly stored in the buffer memory 120.

As described above, in the example illustrated in FIG. 12, the processor 121 constantly monitors whether or not it is possible to generate a pair of an access request addressed to one of the four memory chips CP0-0 to CP0-3 as an access destination and an access request addressed to one of the four memory chips CP1-0 to CP1-3 as an access destination from among one or more access requests in the buffer memory 120. Then, when the pair can be generated, the processor 121 acquires the pair from the buffer memory 120, and inputs each of the two access requests forming the pair to the corresponding flash controller 14.

Note that operation of the scheduler 12 can be variously modified.

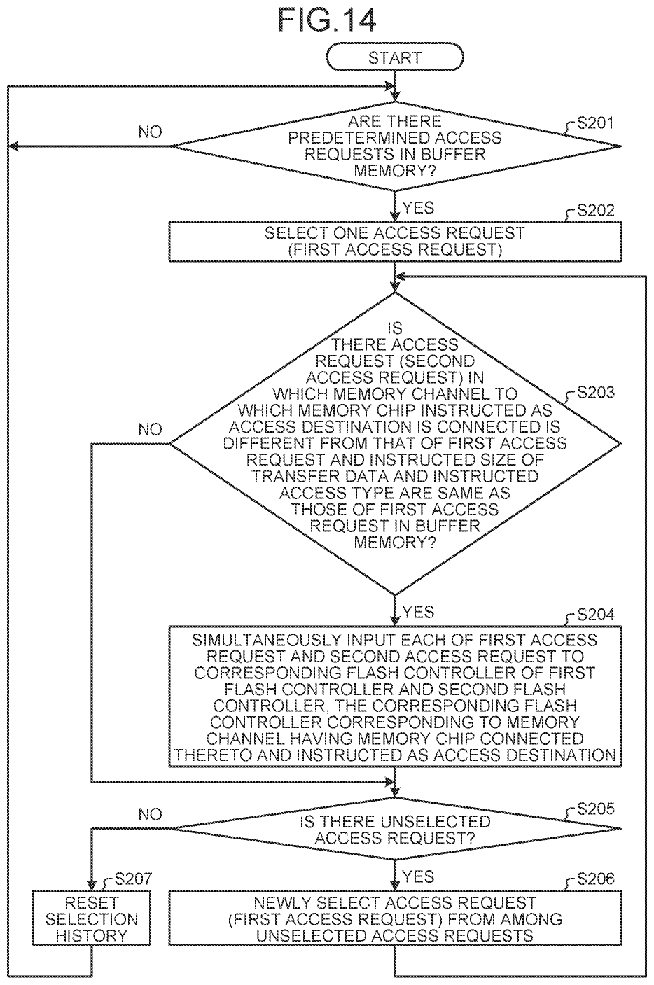

FIG. 14 is a flowchart illustrating another example of the operation of the scheduler 12 according to the embodiment. Here, a description of the operation of storing the access request in the buffer memory 120 is omitted. When an access request is issued by the CPU 11, the access request is stored in the buffer memory 120 asynchronously with a series of operations illustrated in FIG. 14.

First, the processor 121 determines whether a predetermined number of access requests exist in the buffer memory 120 (S201). When the number of access requests stored in the buffer memory 120 is less than the predetermined number (S201: No), the processor 121 executes the determination processing in S201 again to postpone the execution of the next processing until the number of access requests stored in the buffer memory 120 reaches the predetermined number.

When the predetermined number of access requests exist in the buffer memory 120 (S201: Yes), the processor 121 selects one access request from the predetermined number of access requests stored in the buffer memory 120 (S202). The access request selected in the processing in S202 is referred to as a first access request.

Subsequently, the processor 121 determines whether or not there is an access request in which the memory channel MCH to which the memory chip CP designated as an access destination is connected is different from that of the first access request and the designated size of the transfer data and the designated access type are the same as those of the first access request in the buffer memory 120 (S203). The access request in which the memory channel MCH is different from that of the first access request and the designated size of the transfer data and the designated access type are the same as those of the first access request is referred to as a second access request.

When the second access request exists in the buffer memory 120 (S203: Yes), the processor 121 simultaneously inputs each of the first access request and the second access request to a corresponding flash controller 14 of the first flash controller 14-0 and the second flash controller 14-1, the corresponding flash controller 14 corresponding to the memory channel MCH having the memory chip CP connected thereto and designated as an access destination (S204).

When the second access request does not exist in the buffer memory 120 (S203: No), or after S204, the processor 121 determines whether an access request that has not yet been selected as the first access request exists in the buffer memory 120 (S205).

When there is an access request that has not yet been selected as the first access request in the buffer memory 120 (S205: Yes), the processor 121 newly selects an access request from among the access requests that have not yet been selected as the first access request (S206). Then, the processor 121 repeats the operation from S203 using the access request selected in S206 as the first access request.

When there is no access request that has not yet been selected as the first access request in the buffer memory 120 (S205: No), the processor 121 resets a history of selection as the first access request (S207), and executes the processing in S201 again.

As described above, the scheduler 12 may wait for generation of a pair of access requests until the predetermined number of access requests are accumulated in the buffer memory 120.

Hereinabove, a description has been given as to an example in which one semiconductor memory device 1 is connected to the memory controller MC by one host channel HCH. The technique of the embodiment is also applicable to a memory system including two or more semiconductor memory devices 1.

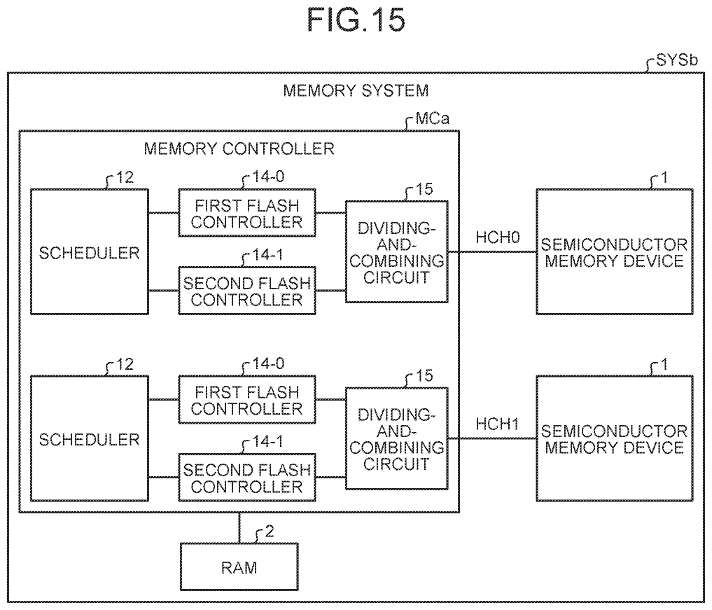

FIG. 15 is a schematic diagram illustrating another example of the configuration of the memory system of the embodiment. A memory system SYSb illustrated in this drawing includes two semiconductor memory devices 1 as an example of the two or more semiconductor memory devices 1. One of the two semiconductor memory devices 1 is connected to a memory controller MCa by a host channel HCH0. The other one of the two semiconductor memory devices 1 is connected to the memory controller MCa by a host channel HCH1.

The memory controller MCa includes, for each host channel HCH, a set of a scheduler 12, two flash controllers 14, and a dividing-and-combining circuit 15. The scheduler 12, the two flash controllers 14, and the dividing-and-combining circuit 15 forming each set perform the same operation as that of the components having the same names described with reference to FIGS. 1 to 14.

In addition, the example in which the semiconductor memory device 1 includes the two memory channels MCH has been described above. The semiconductor memory device 1 may include three or more memory channels MCH, and one or more memory chips CP may be connected to each of the memory channels MCH.

For example, in order to enable control of the semiconductor memory device 1 that includes N memory channels MCH (where N is an integer of 2 or more) each being connected to one or more memory chips CP, the memory controller MC is provided with N or more than N flash controllers 14 for one host channel HCH. Then, the scheduler 12 sequentially acquires, from among the access requests stored in the buffer memory 120, a set of M access requests (where M is an integer of 2 to N inclusive) in which designated sizes of transfer data and designated access types are common to those access requests and the memory channels MCH to which the designated memory chips CP as access destinations are connected are different from each other. Then, the scheduler 12 inputs each of the M access requests of the acquired set to different flash controllers 14 out of the N flash controllers 14. The M flash controllers 14 out of the N flash controllers 14, to which the M access requests of the acquired set have been input, perform data transfer on the basis of the respective access requests.

In a case where the access type designated in each of the M access requests is Write, the dividing-and-combining circuit 15 combines M data strings transferred by the M flash controllers 14 into one data string as a post-combining data string, and outputs the one data string at a transfer rate M times the transfer rate of the memory channel MCH. In the semiconductor memory device 1, the dividing-and-combining circuit 112 divides the received one data string into M pieces of data corresponding to pre-combining data. Each of the M pieces of data is transferred to the memory chip CP serving as the access destination.

In a case where the access type designated by each of the M access requests is Read, each of the M flash controllers 14, to which one of the M access requests has been input, prompts the memory chip CP serving as the access destination to output data. In the semiconductor memory device 1, the dividing-and-combining circuit 112 combines M data strings output from the M memory chips CP into one data string as a post-combining data string, and outputs the one data string at a transfer rate M times the transfer rate of the memory channel MCH. In the memory controller MC, the dividing-and-combining circuit 15 divides the received one data string into M pieces of data corresponding to pre-combining data, and distributes the M data strings to the M flash controllers 14. At this time, the dividing-and-combining circuit 15 outputs each of the M data strings to the flash controller 14 at a transfer rate of 1/M of the transfer rate of the received one data string, that is, at the same transfer rate as the transfer rate of the memory channel MCH.

As described above, according to the embodiment, the memory controller MC includes the flash controllers 14 that transfer or output data to one of the memory chips CP, which serves as an access destination in the semiconductor memory device 1 while performing processing related to error suppression on the data. The memory controller MC includes the dividing-and-combining circuit 15 provided between the flash controllers 14 and the host channel HCH. The dividing-and-combining circuit 15 combines the data transferred from the flash controllers 14 and transfers post-combining data to the host channel HCH. The dividing-and-combining circuit 15 transfers the post-combining data to the host channel HCH at a transfer rate that is a first number times the transfer rate of each piece of pre-combining data. The first number is equal to the number of pieces of the pre-combining data. In addition, the dividing-and-combining circuit 15 divides data received via the host channel HCH into pieces of data, and distributes the pieces of data to a second number of flash controllers 14 at a transfer rate that is one-the second number of the transfer rate of pre-dividing data.

Therefore, the memory controller MC mounted in the memory systems SYS and SYSb of the embodiment can be implemented by only a slight design change with respect to a memory controller that can be mounted in a general memory system. That is, the memory systems SYS and SYSb of the embodiments have a suitable configuration.

In addition, according to the embodiment, the CPU 11 designates a memory chip CP as an access destination, and generates access requests designating the access type and the size of the transfer data. The scheduler 12 identifies two or more access requests from among the access requests generated by the CPU 11. The two or more access requests represent that the memory channels MCH connected to the memory chips CP designated as access destinations are different from each other and the designated access types and the designated sizes of transfer data are common to the two or more access requests. Then, the scheduler 12 inputs each of the two or more access requests to the corresponding flash controller 14 of the flash controllers 14.

Different data transfers are simultaneously executed through the different memory channels MCH to which the memory chips CP designated as the access destinations are connected. Therefore, it is possible to raise the transfer rate between the memory controller MC and the semiconductor memory device 1.

Moreover, according to the embodiment, the scheduler 12 correlates the memory channels MCH with the flash controllers 14 on the one-to-one basis. Then, the scheduler 12 inputs the access request to one of the flash controllers 14, which corresponds to the memory channel MCH connected to the memory chip CP designated as an access destination by the access request.

It is noted that the method of determining the flash controller 14 to which the access request is input by the scheduler 12 is not limited thereto.

Moreover, according to the embodiment, the processing related error suppression includes error correction coding and error correction by the ECC circuit 140.

As described above, it is sufficient that the ECC circuit 140 of each flash controller 14 has specifications capable of executing error correction coding and error correction on pre-combining transfer data, the transfer data being transferred at the same transfer rate as the transfer rate of the memory channel MCH having one memory chip CP serving as an access destination. Therefore, a manufacturer who manufactures a general memory system in which a memory chip is connected to a memory controller without passing through a bridge chip can use an ECC mounted on the general memory system as it is as the ECC circuit 140 of the embodiment.

In addition, according to the embodiment, the processing related to error suppression is randomization processing by the randomizer 141 and reverse processing of the randomization processing.

Therefore, as in the case of the ECC circuit 140, a manufacturer who manufactures a general memory system in which a memory chip is connected to a memory controller without passing through a bridge chip can use a randomizer mounted on the general memory system as it is as the randomizer 141 of the embodiment.

While certain embodiments have been described, these embodiments have been presented by way of example only, and are not intended to limit the scope of the inventions. Indeed, the novel embodiments described herein may be embodied in a variety of other forms; moreover, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A memory system comprising:
a semiconductor memory device including
a first device,
second devices each including a memory cell array, and
first channels connected to the first device, each of the first channels being connected to one or more of the second devices; and
a control device including
first circuits connected to the first device via a second channel, each of the first circuits being configured to transfer and output data to one of the second devices as an access destination while performing processing related to error suppression on the data, and
a second circuit provided between the first circuits and the second channel, the second circuit being configured to combine pieces of data transferred by the first circuits and transfer combined data to the second channel at a transfer rate of n times (n represents an integer) a transfer rate of each piece of pre-combing data, the second circuit being configured to divide data received via the second channel into pieces of data and distribute the pieces of data to m of the first circuits (m represents an integer) at a transfer rate of 1/m times a transfer rate of pre-dividing data, the n being the number of pieces of the pre-combing data and the m being the number of pieces of divided data.

2. The memory system according to claim 1, wherein
the control device further includes:
a third circuit configured to generate access requests, each of the access requests designating one of the second devices as an access destination and designating an access type and a size of transfer data; and
a fourth circuit configured to identify two or more of the access requests and input each of the two or more of the access requests to a different one of the first circuits, the two or more of the access requests representing that the second devices designated as access destinations are each connected to a different one of the first channels and representing that the designated access type and the designated size of transfer are each common to the two or more of the access requests, and
one of the first circuits, to which one of the two or more of the access requests is input, executes transfer of data to the second device designated as an access destination by the one of the two or more of the access requests, the transfer of data being executed with the access type and the size of transfer designated by the one of the two or more of the access requests.

3. The memory system according to claim 2, wherein the fourth circuit is configured to:
correlate the first channels with the first circuits on the one-to-one basis, and
input each of the two or more access requests to a corresponding one of the first circuits being correlated with the first channel to which the second device designated as an access destination is connected.

4. The memory system according to claim 1, wherein the processing related to the error suppression includes error correction coding and error correction.

5. The memory system according to claim 2, wherein the processing related to the error suppression includes error correction coding and error correction.

6. The memory system according to claim 3, wherein the processing related to the error suppression includes error correction coding and error correction.

7. The memory system according to claim 1, wherein the processing related to the error suppression includes randomization and reverse processing of the randomization.

8. The memory system according to claim 2, wherein the processing related to the error suppression includes randomization and reverse processing of the randomization.

9. The memory system according to claim 3, wherein the processing related to the error suppression includes randomization and reverse processing of the randomization.

10. A control device connectable to a semiconductor memory device via a first channel, the semiconductor memory device including memory chips each including a memory cell array, the control device comprising:
first circuits; and
a second circuit connected to each of the first circuits and the first channel, wherein
each of the first circuits is configured to transfer and output data to one of the memory chips as an access destination while performing processing related to error suppression on the data, and
the second circuit is configured to combine pieces of data transferred by the first circuits and transfer combined data to the first channel at a transfer rate of n (n represents an integer) times a transfer rate of each piece of pre-combing data, the second circuit being configured to divide data received via the first channel into pieces of data and distribute the pieces of data to m of the first circuits (m represents an integer) at a transfer rate of 1/m times a transfer rate of pre-dividing data, the n being the number of pieces of the pre-combing data and the m being the number of pieces of divided data.

11. The control device according to claim 10, wherein
the semiconductor memory device includes second channels each being connected to one or more of the memory chips,
the control device further comprises:
a third circuit configured to generate access requests, each of the access requests designating one of the memory chips as an access destination and designating an access type and a size of transfer data; and
a fourth circuit configured to identify two or more of the access requests and input each of the two or more of the access requests to a different one of the first circuits, the two or more of the access requests representing that the memory chips designated as access destinations are each connected to a different one of the second channels and representing that the designated access type and the designated size of transfer are each common to the two or more of the access requests, and
one of the first circuits, to which one of the two or more of the access requests is input, executes transfer of data to the memory chip designated as an access destination by the one of the two or more of the access requests, the transfer of data being executed with the access type and the size of transfer designated by the one of the two or more of the access requests.

12. The control device according to claim 11, wherein the fourth circuit is configured to:
correlate the second channels with the first circuits on the one-to-one basis, and
input each of the two or more access requests to a corresponding one of the first circuits being correlated with the second channel to which the memory chip designated as an access destination is connected.

13. The control device according to claim 10, wherein the processing related to the error suppression includes error correction coding and error correction.

14. The control device according to claim 11, wherein the processing related to the error suppression includes error correction coding and error correction.

15. The control device according to claim 12, wherein the processing related to the error suppression includes error correction coding and error correction.

16. The control device according to claim 10, wherein the processing related to the error suppression includes randomization and reverse processing of the randomization.

17. The control device according to claim 11, wherein the processing related to the error suppression includes randomization and reverse processing of the randomization.

18. The control device according to claim 12, wherein the processing related to the error suppression includes randomization and reverse processing of the randomization.

19. A method of controlling a semiconductor memory device, the semiconductor memory device including a first device, second devices each including a memory cell array, and first channels connected to the first device, each of the first channels being connected to one or more of the second devices, the method comprising:
causing each of different ones of the first circuits to execute each of two or more access requests designating, as an access destination, each of the second devices connected to the different ones of the first channels; and
causing each of the first circuits to transfer and output data to the second device designated as an access destination while performing processing related to error suppression on the data;
in a case where each of two or more of the first circuits executing one of the two or more access requests transfers data,
combining pieces of data transferred by the two or more of the first circuits and transferring combined data to the semiconductor memory device at a transfer rate of n (n represents an integer) times a transfer rate of each piece of pre-combing data, the n being the number of pieces of the pre-combing data; and
in a case where each of the two or more of the first circuits outputs data to a corresponding designated access destination,
dividing data received from the semiconductor memory device into two or more pieces of data to be respectively output by the two or more of the first circuits to the corresponding access destinations, and
distributing the two or more pieces of data to m of the first circuits (m represents an integer) at a transfer rate of 1/m times a transfer rate of pre-dividing data, the m being the number of pieces of divided data.

20. The method according to claim 19, further comprising:
generating access requests, each of the access requests designating one of the second devices as an access destination and designating an access type and a size of transfer data; and
identifying two or more of the access requests and inputting each of the two or more of the access requests to a different one of the first circuits, the two or more of the access requests representing that the second devices designated as access destinations are each connected to a different one of the first channels and representing that the designated access type and the designated size of transfer are each common to the two or more of the access requests,
wherein one of the first circuits, to which one of the two or more of the access requests is input, executes transfer of data to the second device designated as an access destination by the one of the two or more of the access requests, the transfer of data being executed with the access type and the size of transfer designated by the one of the two or more of the access requests.
